(19) United States
(12) Patent Application Publication
(10) Pub. No.: US 2006/0162864 A1
(43) Pub. Date: Jul. 27, 2006

(54) Methods and envelopes for rational sealing of documents and inserts of different kinds in envelopes

(76) Inventor: Olof Karlsson, Karlskoga (SE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/527,163

(22) PCT Filed: Sep. 10, 2002
(86) PCT No.: PCT/SE02/01616

§ 371 Date: Apr. 11, 2005

(51) Int. Cl. B43M 3/00

(52) U.S. Cl. 156/441.5

(57) ABSTRACT

A method of sealing envelopes after inserting content. The sealing is done by embossing and the method is simple, fast and environmental friendly. Slightly modified conventional envelopes are used but there is no glue needed along the open edge. The sealing method may be used over the full scale from industrial inserting machines through office machines to simple home machinery. Also described is th production of envelopes from plain paper for use in industrial inserting machines. The method may also be used to fix the position of credit cards, CD's and similar inserts in an envelope, and to reinforce a secure sealing of a conventional envelope.

### BACKGROUND ART

This invention covers a field where putting documents into envelopes normally is carried out with the use of envelopes or elements for envelopes manufactured with various conventional sealing techniques but where the final sealing according to this patent application is performed by an embossing technique.

Ordinary envelopes are sealed with a paper flap with a string of glue fastening to the outer side of the envelope. The glue can be either water-soluble glue or any other glue as heat or pressure sensitive or self-adhesive. The heat in a laser printer affects this later category of glues and it is due to this unsuitable to add addresses etc. to these envelopes by printing in a printer. Instead window envelopes are commonly used where the address is incorporated at the enclosed document or the address is attached to the outside of an ordinary envelope as an address label. Window envelopes are more expensive and the address labels implies the use of special equipment or manual handle with accompanying risks of handling faults.

Mail inserting machines folding and gluing envelopes with water-based glue are frequently existing but the use of water makes the machines complicated and requires maintenance and cleaning in order to give a reliable operation.

Known machinery is mechanically complicated. There are problems to lift the envelope flap, moisten the glue strip and then fold the flap back. The envelope flap shall shut and seal the envelope. The machinery handling time with the flap and the gluing procedure takes some time and is limiting the mail inserting speed.

### OUTLINE OF THE INVENTION

Embossing as a technique to join two papers is a known technique, which is simple, fast and requires no additives.

In patent applications SE 9803525-6, SE 0004205-1, SE 0103145-9 and PCT/SE01/02537 is described how the technique can be used in order to, in one operation, create an envelope by using embossing technique to seal the outer side and enclosed documents, if any, solely by the use of plain paper sheets as starting material.

This patent application deals with how embossing technique can be applied to prefabricated envelopes or material for envelopes in order to obtain a simpler and flexible sealing operation without any additives. The simplification is predicted to gain great influence to envelope sealing by machinery. The envelopes and methods according to this patent application can be used, with advantage, instead of the plane paper envelopes described in the patent applications mentioned above.

The mechanical design of the machines for the plurality of the patent claims of this patent application will be simple, since the sealing of these envelopes is a one-directional operation instead of a two-directional.

Also high speed, high volume industrial inserting machines may take advantage of the simple technique, which is both fast and reliable. A module of the sealing mechanism can with advantage be incorporated in to-days large inserting machines.

In this patent application is also dealt with how the sealing technique can be used to stick together documents which not necessarily must be entirely sealed, as e.g. mailshots. Furthermore is shown how credit cards, CD-ROM: s and other similar dispatches can be fixed inside the envelope or on inserts.

Finally is shown a process to make an envelope secrecy-safe in such a way that if the envelope is opened it will torn. (Normally glue sealed envelopes can be opened and resealed without it can be detected.)

### TECHNICAL FIELD

There are patent applications describing procedures to manufacture envelopes in the same operation as the documents are printed. The procedure is described in the patent applications mentioned above and is called embossing. Only plain paper sheets are used and the process is well suited for use in office (business) machines but also for industrial applications.

Envelopes sealed according to this patent application are preferably intended to be used with mail inserting machines but can also be used with office machines or at hand-operated embossing in the same way as is shown in patent application SE 0103145-9.

Sealing by means of embossing is applicable and usable as well with other processes and basic material for the envelopes than stated in the patent applications mentioned above. When embossing is stated in “Disclosure of Invention” below, the embossing can be continuous or split up into sections with space in-between or consist of limited areas. It is made with embossing wheels or tools for punching. The embossing can be performed in one or several rows/fields.

In “Disclosure of Invention” below different designs is shown with reference to the various drawings.

### DISCLOSURE OF INVENTION

1. Envelope without Flap or Material for Envelope without Flap.

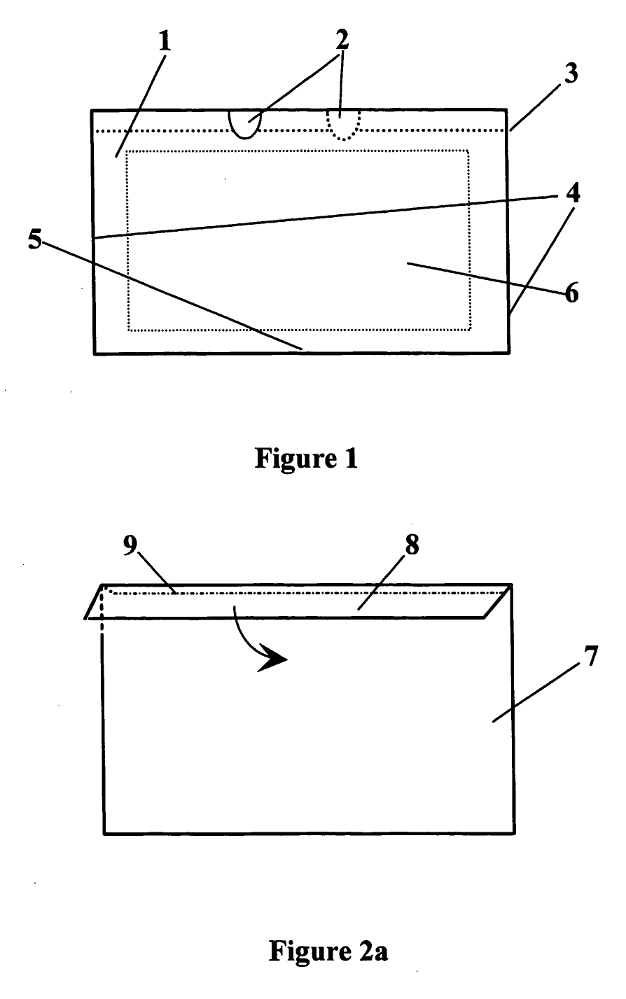

FIG. 1 shows an envelope of this design where (1) is the envelope itself, (2) indicates notches in one or both paper sides of the envelope, (3) shows the final sealing embossing, (4) the sealed side edges, (5) the sealed bottom edge and (6) the enclosed document.

The sealed side edges (4) may be sealed by embossing or by glue and the sealed bottom edge may preferably have been produced by folding the paper constituting the envelope or by gluing or embossing of the bottom edge.

The notches (2) in the upper paper sides are meant for facilitating opening of the envelope as well at the insert procedure in the mail inserter as at opening of the sealed envelope.

The sealing of the envelope (3) takes place as the last phase according to the principles shown in the patent applications referred to above.

The envelope may be run through a printer if desired. It may be fitted with window. The open edge is embossed after insert of the content. Only one edge needs to be embossed, an operation, which preferably is performed when the mail leaves the machine. The process is fast and the seal has its full strength immediately after the sealing.

Neither glue, liquid nor heat needs to be added, something that otherwise is quite common.

It is simple to adapt the process to different envelope sizes as embossing is performed at one edge only. The notches may be one or several and are placed both at the front and at the back, they are not overlapping each other and their appearance may be varying, for example they may consist of holes or merely by cuts in the paper. The embossing joint, which is strong, is easy to open by slitting open with a paperknife from these notches.

1a. Envelope with Flap or Material for Envelope with Flap

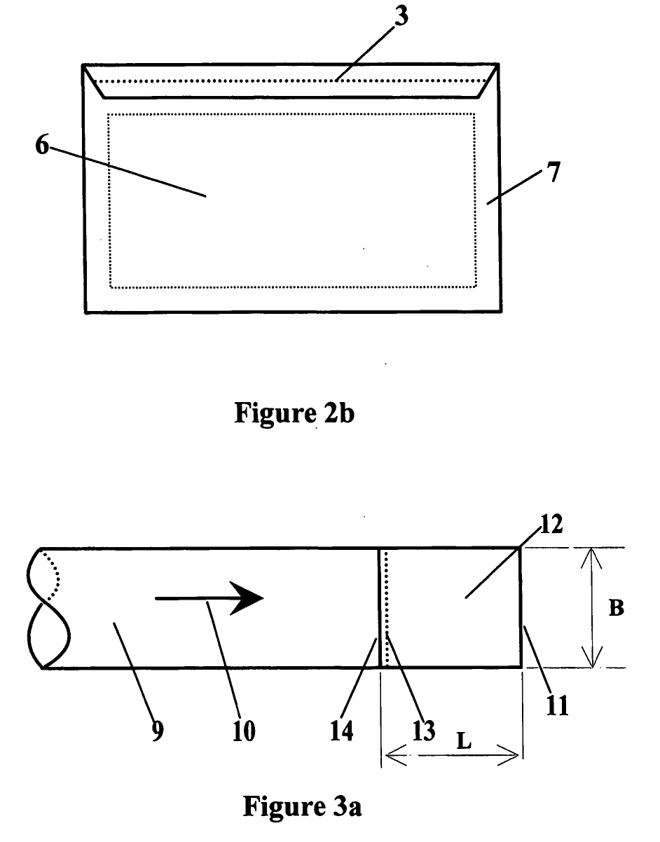

FIG. 2a shows this type of envelope where (7) is the envelope manufactured in a conventional manner or by basic material as that under 1 above. The flap (8) is folded over the back and (9) indicates the upper edge of the back, which should extend as high up towards the folding as possible.

FIG. 2b shows the envelope after the sealing procedure by means of embossing (3) and with an enclosed document (6).

The only difference when compared with a conventional envelope is that the flap is sealed through embossing after the letter is inserted. The embossing thus joins three layers of paper namely the flap, the back and the front of the envelope.

The back of the envelope ought to extend as close as possible towards the folding of the flap so that the embossing seal can be placed close to the edge of the envelope in order not to limit the space for the content of the envelope.

The edge of this type of envelope is stronger then that of an envelope manufactured according to 1 above.

Notches, as described in 1 above, may also be applied.

2. Envelope in the Shape of “A Flattened Endless Paper Tube”

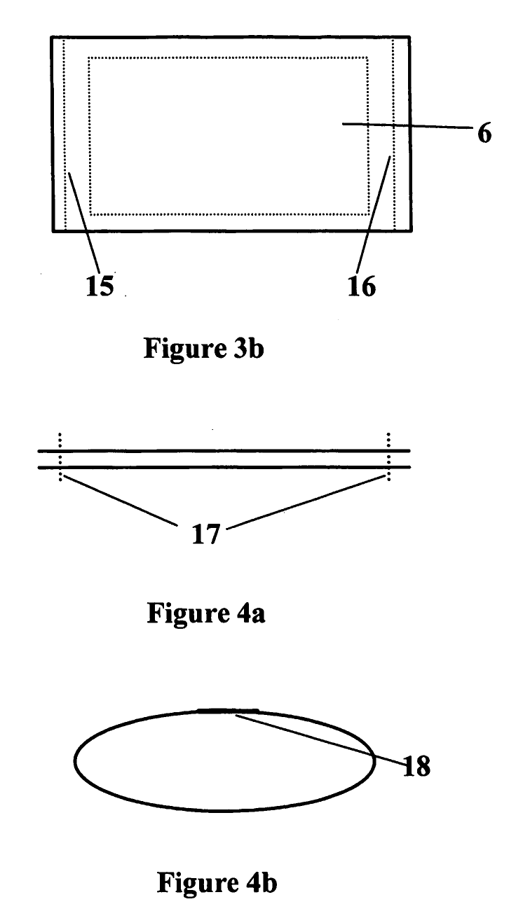

FIG. 3a shows the manufacture of envelopes deriving from material in the shape of a paper tube. The material consists of a flattened tube of paper (9) that during the production is moved in direction (10). The material is at the following working operation cut off at (11) and the flattened tube thus opens there.

At the manufacturing of the envelope (12) the tube is sealed by embossing at (13) then the tube is cut at (14).

The final envelope is shown in FIG. 3b after mail insert and sealing where the embossing (15) is the embossing in the previous operation stage—(13) in FIG. 3a—and (16) is the final sealing after the insert of the content (6).

The material for the envelopes can be available as flattened tube of standard length or on rolls. The material may even have windows when manufacturing window envelopes.

The dimensions (B) and (L) shown in FIG. 3a represent the width respectively the length of the manufactured envelopes. By choosing different lengths (L) one can manufacture different envelope sizes with one and the same width (B). Using one width enables manufacturing of e.g. the standard letter sizes C4, C5 and C65.

Printing on the envelope or the material for the envelope may be performed and only one embossing direction is used. The process in the inserting machine may be worked out in different ways.

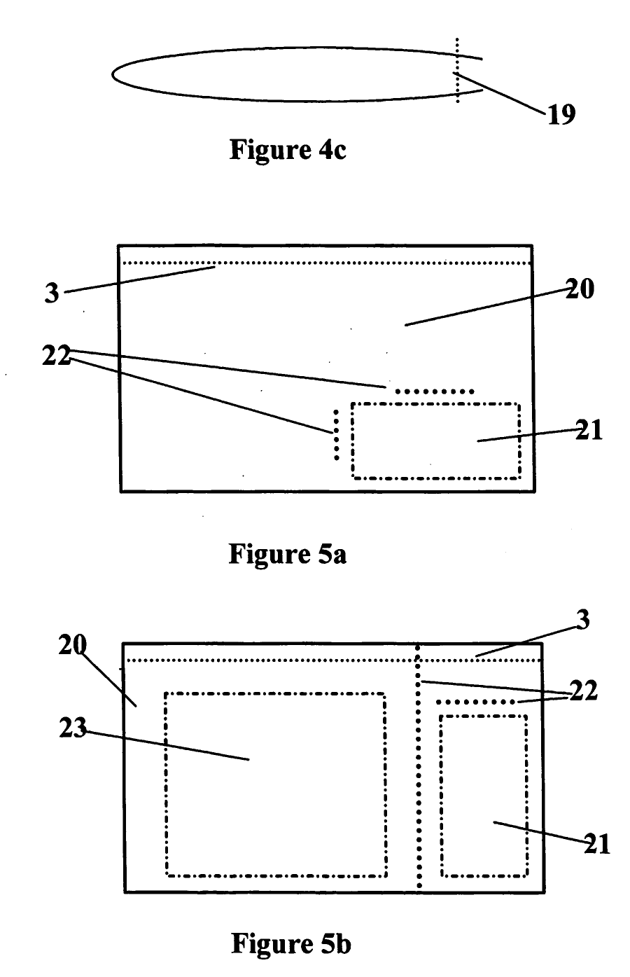

Different methods to produce envelope material are shown in FIGS. 4a, 4b and 4c. The paper may be taken from rolls, as in to-days envelope-producing machines or it may consist of plane paper sheets.

In FIG. 4a is shown the production of “tubes” manufactured of plain paper of desired size by embossing (17) along two edges.

FIG. 4b shows a tube produced from a length of paper by folding and sealing the overlapping by embossing or gluing (18).

FIG. 4c shows how folding a length of paper and sealing it along a long side (19) by embossing or gluing may produce a tube.

Delimitation of space in envelopes.

If an envelope shall contain documents as well as other details as e.g. credit cards, CD-ROMs or similar details, it is possible to secure the detail to the intended place in the envelope by embossing.

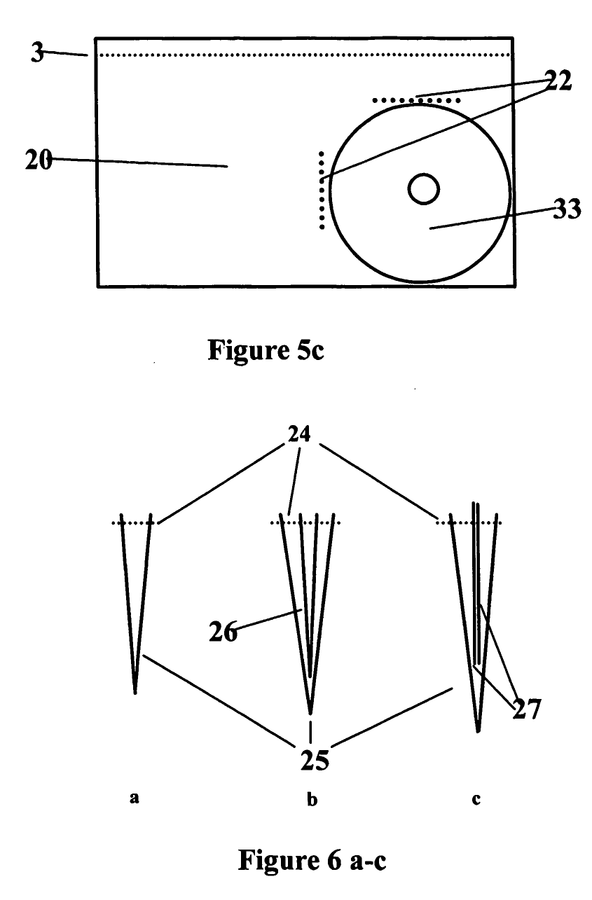

FIG. 5a shows an envelope (20) with some sort of plastic card (21) enclosed where the card is secured with the two rows of embossing (22). The envelope is then in normal way sealed by embossing (3).

FIG. 5b shows an envelope (20) where part of the inside space is reserved for a document (23) and one part of the space has been reserved for a plastic card or other detail (21) and where the positioning of the details has been done by embossing (22). The envelope is then in normal way sealed by embossing (3).

FIG. 5c finally shows an envelope (20) with an insert of a CD-ROM (33) where the position of the CD-ROM is secured by the embossing (22) and then is sealed by embossing (3).

Besides equipping the envelope with partitions the inserts may in a corresponding way be fastened to a folded paper that is inserted into an envelope which is then sealed.

This technique for delimitation of space or fastening may be used on any type of paper envelope, not just these described in this patent application.

3. A Non-Sealed Envelope.

Less important messages—e.g. leaflets—need necessarily not be sent in sealed envelopes. The FIGS. 6a-6c show some variants.

FIG. 6a shows a document where the information is found at the inner side of the wrapping and where the sealing is performed only at one edge (24).

FIG. 6b shows a design where the consignment (25) also contains a folded document (26) which is fixed at the sealing operation by embossing (24).

FIG. 6c finally shows how several documents (27) in the same way are fixed to the wrapping (25) at the sealing (24).

5. Batch of Documents or Leaflets.

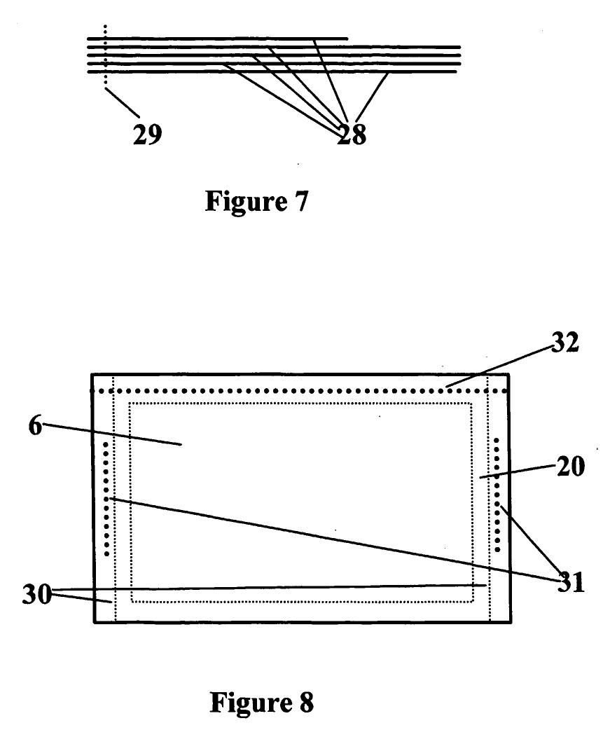

FIG. 7 shows a procedure that with advantage may be used to stick together a number of papers as e.g. leaflets or similar documents.

The papers/documents (28) may be of varying sizes and are stuck together by embossing preferably along a longer side (29).

4. Secrecy Guarded Envelope.

Ordinary conventionally manufactured envelopes, where gluing has been used for sealing, are fairly simple to open and then reseal without necessarily anybody noticing it. By providing an envelope with embossing joints—partly or all over—it will be obvious if the envelope has been opened.

In FIG. 8 is shown how the glued edges (30) of the envelope has been reinforced in the glue sealing by embossing (31) as well as the glued sealing of the envelope has been reinforced by embossing (32). The enclosed consignment is shown as (6).

1. Method for filling and sealing of an envelope comprising the steps of:
a) supplying of an envelope (1), where appropriate equipped with address indication or similar printed on it, consisting of two sheets which along at least one first part of its periphery (5) are integral with or joined together, as an example the sheets are connected to each other along a folding line which folding line divides one sheet into two sheets, and which first part of the periphery of the sheets constitutes a first part of the periphery of the envelope and at the same the sheets at least at a second part of their periphery are separated from each other and thus the envelope along the second part of the periphery of the sheets is open and thus the sheets have edges overlapping each other along this second part of the periphery of sheets thus forming the second part of the periphery of the envelope,
b) separation of the edges of the sheets along at least some part of this second part of the periphery of the envelope thus widening an opening in the area for the second part of the periphery of the envelope,
c) insert of an object (6) through the widened opening thus enabling the object to get into the envelope,
d) embossing the overlapping edges of the sheets (3) along the second part of the periphery of the envelope so that the envelope by embossing is sealed along the second part of its periphery.

2. Method according to claim 1, characterised by the design of the envelope which is fitted with at least one notch in the second part of the periphery (2) of the envelope so at least one of the sheets in the second part of its periphery has one notch which may be used to facilitate insert of the content into the envelope and also future opening of the sealed envelope.

3. Method to seal an envelope comprising the steps of:
a) supplying of an envelope (7), consisting of two sheets which at least along one part of their periphery are stuck together, for instance along a folding line, a glue joint or by embossing and where one of the sheets is equipped with a foldable flap (8) located in connection to a longitudinal opening in the envelope,
b) insert of an object (6) through the widened opening thus enabling the object to get into the envelope,
c) folding the foldable flap over the longitudinal opening of the envelope so that the flap over at least part of its surface is overlapping both sheets,
d) embossing the flap and the two sheets so that the embossing (3) is joining the flap and the two sheets to each other.

4. A sealed envelope (7) according to claim 3 which envelope comprises:
a) one first sheet,
b) one second sheet which second sheet sticks together with and overlaps the first sheet,
c) on the second sheet, a flap which has been folded down over part of the first sheet so that at least a part of the flap is overlapping as well a part of the first sheet as a part of the second sheet and as a result the flap, the first sheet and the second sheet at the sealing of the envelope becomes embossed to each other.

5. Method according to claim 1 characterised by the fact that the envelope constitutes a part of a long paper tube which is material for quite a number of envelopes separated from each other in the longitudinal direction of the paper tube by embossing joints (13) perpendicular to the longitudinal direction of the paper tube and manufactured at the production of the envelopes.

6. Method to position several separate consignments in envelopes according to the method in claim 5 which method contains the following operations:
a) supplying of a number of separate consignments intended to be sent to different addresses when at least one first consignment at wait state for the consignments,
b) supplying of a long, flattened paper tube which paper tube has at least one open side.

7. Method according to claim 6 characterised by the case that the consignments may be of different sizes and that, for each consignment, a part of the paper tube is advanced a length corresponding to a dimension of the consignment to be conveyed into this part of the paper tube.

8. Method according to claim 6 characterised by the fact that consignments are inserted at an area of the paper tube via an open side (11) of the paper tube perpendicular to the direction of feed of the paper tube.

9. Method according to claim 6 characterised by the fact that the open side (11) via which a consignment has been entered into a section of the paper tube is sealed by embossing of opposite parts of the paper tube.

10. Method according to claim 5 characterised by the fact that the section of the paper tube receiving the first consignment, after the cutting operation, is sealed adjacent to the area where the reminder part of the paper tube after separation of the envelope has been cut.

11. Method according to claim 5 characterised by forming the paper tube from two sheets of paper by embossing them together.

12. Method according to claim 5 characterised by forming the paper tube as an overlapping folding of a long sheet of paper which is glued or embossed in the folding.

13. Method according to claim 5 characterised by forming the paper tube by folding a long sheet of paper which then is embossed along its open long side.

14. Method for positioning of one or several essentially flat objects in an envelope which method involves the following operations:
a) supplying of at least one essentially flat object intended to be sent in an envelope,
b) supplying of an envelope larger than the essentially flat object so that the flat object only may take up part of the inner space of the envelope,
c) insertion of the essentially flat object into the envelope and
d) embossing of each other opposite pages of the envelope in an area of the envelope located close to the essentially flat object so that the flat object by that is fastened to a limited area of the envelope,
e) sealing of the envelope.

15. Method according to claim 14 characterised by the sealing of the open envelope is performed by embossing.

16. Method according to claim 14 characterised by performing a number of embossings in order to limit the position of the flat object in more than one dimension.

17. Method according to claim 14 characterised by the positioning of a number of essentially flat objects in the envelope and that each flat object placed in the envelope is secured in its own limited area by embossing.

18. Envelope containing one or more essentially flat objects which envelope has each other opposite pages embossed with each other in at least an area of the envelope situated close into the flat object so that the flat object/objects thus is/are secured into a limited part of the envelope.

19. Envelope according to claim 18 characterised by containing a number of essentially flat objects of which at least one flat object is located in one by embossing limited part of the envelope and one or more of the other flat objects are located in other by embossing limited parts of the envelope.

20. Method to produce a document containing several sheets, e.g. a leaflet which method incorporates the following operations:
a) supplying of a number of sheets with text and/or symbols written on them and
b) embossing of the sheets with each other along one side of the sheets (29) thus forming a continuous document able to browse through.

21. Document containing a number of sheets with text or symbols written on and which sheets are joined to each other along one of its edges characterised by the fact that the sheets are joined to each other by embossing.

22. Method to seal envelopes comprising the steps of:
a) supplying of an envelope (20),
b) insertion of a consignment into the envelope (6),
c) gluing of the envelope so that the envelope in that way is sealed with a string of glue,
d) embossing of opposite edges of the envelope in the area of the glue seal (31) thus preventing the glue-sealed part of the envelope to be opened without destroying the embossing,
e) securing the seal of the envelope by embossing (32) of the glue seal.

23. Envelope according to claim 22 containing an essentially flat object characterised by having as well opposite edges of the envelope (31) as the seal of the envelope (32) embossed in the areas of the glue seals thus preventing opening of the envelope without destroying the embossing.
